(19) United States
(12) Patent Application Publication
(10) Pub. No.: US 2013/0036657 A1
(43) Pub. Date: Feb. 14, 2013

(54) System, Method, and Apparatus for a Hollow Fishing Hook

(71) Applicant: Dwane K. Stull, Newton Falls, OH (US)

(72) Inventor: Dwane K. Stull, Newton Falls, OH (US)

(21) Appl. No.: 13/234,818

(22) Filed: Sep. 16, 2011

Related U.S. Application Data
(63) Continuation-in-part of application No. 13/207,044, filed on Aug. 10, 2011.

(51) Int. Cl. A01K 83/00; B21F 45/12

(52) U.S. Cl. 43/43.16; 29/9

(57) ABSTRACT

A hollow fishing hook that will avoid the use of knots entirely, simplifying the profile of the fishing hook, making it easier for the end user to attach the leader line to the hook, simplifying manufacturing, reducing the propensity of the hook to catch debris in the water, and creating less auditory and visual distraction of the fish.

### CROSS-REFERENCE TO RELATED APPLICATION

This application is a non-provisional application, and a continuation-in-part of U.S. patent application Ser. No. 13/207,044, filed Aug. 10, 2011, the disclosure of which is hereby incorporated by reference.

### FIELD

This invention relates to the field of fishing and more particularly to a system for attaching a leader line to a fishing hook without tying a knot or binding/lashing the leader line to the hook.

### BACKGROUND

Fishing is an activity that dates back to as far as 40,000 years ago. Hooks for fishing have been found that date back to the Stone Age. The key portion of nearly every fishing system is the hook itself. To be part of the fishing system, the hook must somehow be connected to the user, which is usually done by the use of a fishing line. The means of connecting the generally rigid fishing hook to the flexible fishing line has been a problem fishermen have attempted to address for centuries. The two main methods of attachment are tying a knot that passes through the eye at the top of the hook, or to use a snell knot (i.e., binding/lashing knot), which may or may not pass through an eye at the top of the hook, instead gaining most of its strength from being bound to the hook shaft.

An attempt to solve the problem of attaching a fishing line to a hook is shown in U.S. Pat. No. 1,156,152 to Krenrick, that shows the wrapping that would be provided by the snell knot replaced with a band that crimps around the fishing line. But the line still needs a knot at the end of the line to prevent it from passing through the band, and the hollow portion is not through the center of the fishing hook. Additionally, given that the band is attached to the side of the shank, it creates yet another location for seaweed and other detritus to become caught, fouling the hook, line, and bait.

US Pat. App. 2007/0169399 describes a tube attached to the shank portion of a fishing hook, where the fishing line then passes through the tube. But this device still requires a knot at the end of the line to prevent the hook from slipping off the line, and the tube portion is not at the center of the hook. As discussed above, this attachment mechanism also creates yet another location for debris to become caught.

US Pat. App. 2009/0313878 describes a method for securing fishing line to a hook, where the fishing line is passed around a helical coil, wraps over itself and forms a type of knot. This method still requires the user to tie a knot, makes the hook more complicated rather than less complicated, and creates more turbulence and a greater propensity for catching debris as a result of the complicated shank.

What is needed is a system that will avoid the use of knots entirely, simplifying the profile of the fishing hook, making it easier for the end user to attach the leader line to the hook, simplifying manufacturing, reducing the propensity of the hook to catch debris in the water, and creating less auditory and visual distraction of the fish.

### SUMMARY

A hollow fishing hook device is disclosed comprising an elongated shank, the shank having a cross-sectional shape with a first end and a second end; and a reservoir starting in the first end of the elongated shank, the reservoir comprising a hollow portion of the elongated shank; and the second end of the elongated shank continuing into at least one bent elongated arm, the reservoir continuing through at least a portion of the at least one bent elongated arm, the bent elongated arm ending in a point.

A method of manufacturing a hollow fishing hook device is disclosed, the steps comprising: bending a hollow shaft having a hollow cross section to form a hook shape, the hook shape comprising a shank and a bend, terminating an end of the bend furthest from the shank; and filling a portion of an interior of the tube with at least one type of adhesive.

A hollow fishing hook device comprising an elongated hollow shank is disclosed, the shank having a cross-sectional shape with a first end and a second end; and a reservoir starting in the first end of the elongated hollow shank, the reservoir comprising at least a portion of the elongated hollow shank the second end of the elongated shank continuing into at least one elongated hollow arm, the reservoir continuing through at least a portion of the at least one elongated hollow arm, the elongated hollow arm ending in a point; and the reservoir at least partially filled with at least one adhesive.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates an isometric view of a first embodiment of the hollow fish hook design.

FIGS. 2A and 2B illustrate a second embodiment, showing both an enlarged hollow chamber and a two-part mixable adhesive.

FIG. 3 illustrates a third embodiment, showing both an enlarged hollow chamber and an offset believed to increase the strength of the adhesive bond.

FIGS. 4A and 4B illustrate a two part hook with an adhesive means for attaching the hook to the leader line.

FIGS. 5A and 5B illustrate a two part hook with a mechanical means for attaching the hook to the leader line.

FIGS. 6A and 6B illustrate a fourth embodiment of the hollow fish hook.

FIGS. 7A through 7D illustrate exemplary cross sections.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

Referring to FIG. 1, an embodiment of the hollow shank fishing hook 12 will be described. Like most fishing hooks, the hollow shank fishing hook 12 is comprised of a shank 20, a bend 22, a point 24, and a barb 26. The cross-sectional shape of the hook in the examples shown is generally circular or elliptical, but any shape is anticipated, including square, rectangular, triangular, or any other regular or irregular polygonal shape. This cross sectional shape is elongated to form the length of the shank 20. The bend 22 is an extension of the elongated shank and preferably follows a curved, arcing path, but other shapes are anticipated such as shapes with sharp corners, a series of segments, either straight or curved sections, that in the aggregate create a curve, or even a ninety-degree bends that form a hook bottom. The bend and barb 26 portion of the hollow shank fishing hook 12 is anticipated to be any known or future bend and barb configuration as known in the industry.

The point 24 and barb 26 shown in the figures are typical. Any shape point 24 and barb 26 commonly known in the art are anticipated. While the figures show a hollow shank fishing hook with only one bend 22, associated point 24, and barb 26, any number of bends/points/barbs 22/24/26 is anticipated, including double or treble hooks (i.e., hooks with two or three bends/points/barbs 22/24/26).

Missing from the hollow shank fishing hook 12 is an eye; a necessity for most fishing hooks of the prior art. Instead of an eye, the hollow shank fishing hook 12 has a hollow shank reservoir 30. The fishing line 10 is fed into the reservoir 30 and affixed to the hollow shank fishing hook 12 by a variety of means, in this case, an adhesive 40 fills the reservoir, permanently attaching the hollow shank fishing hook 12 to the fishing line 10. The reservoir as shown in the examples is generally cylindrical and axially aligned with the shank, but there is no requirement of a specific shape or position and any shape and/or position is anticipated. The cross-sectional shape of the reservoir as shown in the examples is generally circular, but any shape is anticipated, including elliptical, square, rectangular, triangular, or any other regular or irregular shape. The reservoir forms a hollow portion within the shank of the hook.

The fishing line 10 is typically made of an artificial material, such as nylon, polyvinylidene fluoride (PVDF), polyethylene, Dacron, etc. But the fishing line 10 is not limited to such materials and is anticipated to be made of any material known in the industry, including natural materials such as cotton, synthetic materials as described, or metals such as aluminum or stainless steel as often used for leader lines. In some embodiments fishing line 10 composed of a single strand (i.e., monofilament) but in other embodiments is constructed of any number of strands. The hollow shank fishing hook 12 is ideal for multifilament line due to the difficulty such line presents when attempting to tie knots. While not required, in the preferred embodiments the fishing line 10 is made of fluorocarbon material composed of fluoropolymer PVDF because it has a refractive index that is very similar to water, making the fishing line 10 nearly invisible to fish. In some embodiments, the fishing line 10 is the main line that is continuous all the way back to the user. In some embodiments, the fishing line 10 is a shorter line known as a “leader line” that is subsequently attached to the main fishing line 10. In embodiments in which the fishing line 10 is a “leader line”, any length of leader line is anticipated, though the leader line is often short (e.g. 12 inches) due to ease of packaging and manufacturing. In embodiments in which the fishing line 10 is the main line that is continuous all the way back to the user, the user determines what type of line is inserted, depending on the desired use.

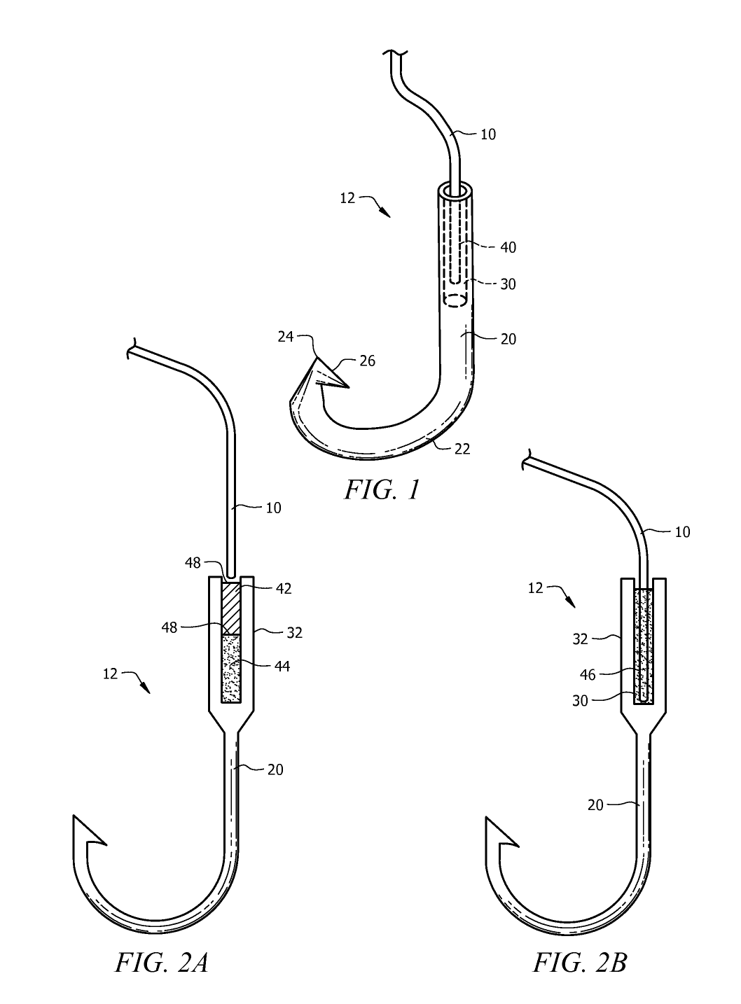

In the example of FIG. 1, either the fishing line 10 is coated with an adhesive before inserting the fishing line 10 into the reservoir 30 or the reservoir 30 is prefilled with an adhesive (see FIGS. 2A and 2B) and either the fishing line 10 is inserted into the reservoir and bonds to the adhesive or the fishing line 10 is pre-treated to initiate bonding (e.g. the end of the fishing line 10 is moistened before insertion into the reservoir 30). In other embodiments, the reservoir 30 is prefilled with adhesive, and crimped/crushed to activate the adhesive. In still other embodiments, the fishing line 10 is inserted into the reservoir, and the adhesive subsequently injected. The adhesive then cures through the passage of time, or by application of an external energy source (e.g., heat).

FIGS. 2A and 2B show another embodiment of the hollow shank fishing hook 12 with a two-part adhesive and an enlarged shank 32 to contain the reservoir. Depending on the relative sizes of the shank 20 and the fishing line 10, in some embodiments, the diameter of the shank 20 is exaggerated or enlarged to create an enlarged shank 32 to allow room for the fishing line 10 and reservoir 30.

FIG. 2A shows a hollow shank fishing hook 12 with a two part adhesive (e.g., epoxy), adhesive part A 42 and adhesive part B 44. There is no requirement that the adhesive only be two part, and in some embodiments is comprised of three or more parts. The adhesives are separated from each other, and the atmosphere, by membranes 48. The membrane 48 is comprised of any material that prevents the relevant liquid or gas from penetrating and activating the adhesive (e.g., prevents the entry of water if the adhesive is water activated, or the escape of the solvent if the solvent evaporates to activate the adhesive, etc.). The fishing line 10 is pushed through the membranes and into the adhesives 42 and 44, mixing the adhesives to initiate bonding. The mixing of the adhesives 42 and 44 starts a chemical reaction, resulting in a cured adhesive 46 that bonds the fishing line 10 to the reservoir 30. In other embodiments, the adhesive is injected using a hypodermic needle that includes a mixing tip. The adhesive, if comprised of multiple parts, is held within multiple containers within the needle, and mixed in the tip during injection into the reservoir 30. The tip may then be broken off, a new reservoir attached, and a new tip used to fill a different reservoir. In some embodiments the adhesive is injected before the line 10 is inserted, and in other embodiments the adhesive is injected after the line 10 is inserted.

In other embodiments, rather than a two part adhesive, a single part adhesive may be used. It is envisioned that the single part adhesive is separated from the atmosphere by an optional membrane 48, as necessary, to prevent premature activation. Single part adhesives cure by, for example, the evaporation of a solvent (e.g., water, alcohol, etc.), a chemical reaction between the adhesive and another chemical (e.g., water vapor, liquid water applied to the fishing line 10 prior to insertion, saliva, oxygen, etc.), or in reaction to an external energy source (e.g., ultraviolet light, heat, etc.). In still other embodiments, the portion of the shank 20 or enlarged shank 32 that contains the reservoir 30 is made of a flexible or malleable material lined with a pressure sensitive adhesive. The fishing line 10 is inserted into the reservoir 30, and the reservoir is compressed to press the adhesive 46 against the fishing line 10.

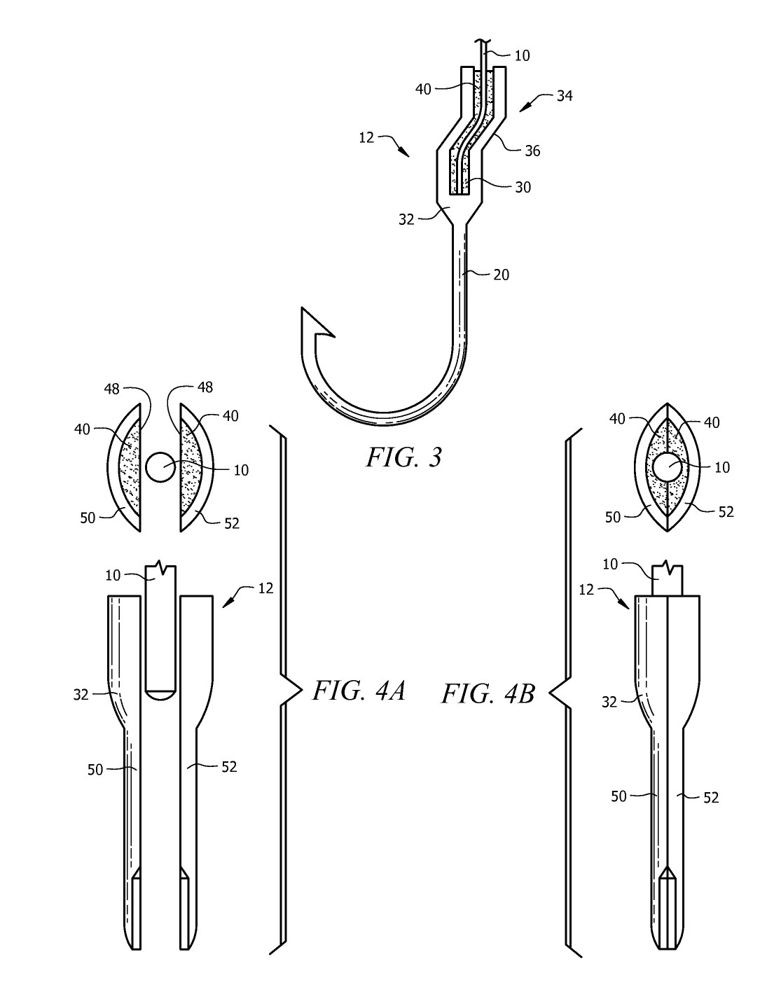

Referring to FIG. 3, the hollow shank fishing hook 12 with crooked shank 34 will be discussed. In this example, a non-linear shank provides a greater sealing strength than a linear shank by dividing the resulting stress between the horizontal and vertical directions. “Non-linear” indicates a portion that is not parallel to the main shank 20 of the hollow shaft fishing hook 12. For an example, for a bond where the adhesive 40 is lining the walls of a linear reservoir, under force, the point of failure (assuming the hook and fishing line do not fail first) is predicted to be the bond between the fishing line 10 and the crooked shank 36. As the fishing line 10 is pulled in a vertically upward direction (parallel to the reservoir 30) and the walls of the reservoir 30 pulled in the opposite direction (e.g. by a fish), it is predicted that the adhesive will shear along one of those surfaces (or within the adhesive itself, if the bond is stronger than the adhesive). As a second example, using the same directional forces as above, it is predicted that in some instances the point of failure (assuming the hook and fishing line do not fail first) is to be the bond between the fishing line 10 and the linear shank 20. The shape of the crooked shank 34 will prevent the fishing line 10 and adhesive 40 from sliding out of the crooked shank 34, preventing the hollow shank fishing hook 12 from disconnecting from the fishing line 10. This bond is strong enough for many fishing applications but there are some applications that require a stronger bond such as sport fishing for game fish such as Marlin and Sailfish.

In embodiments as shown in FIG. 3, the crooked shank 34 along the non-linear section or sections 36 resists pure shear force because the fishing line 10 and the walls of the reservoir 30 are not parallel to the direction of the force. Instead, the load on the adhesive at that point is a mix of shear, tensile, and compressive stresses. Depending on the type of adhesive 40, reservoir 30 material and surface structure, fishing line 10 material and surface structure, the crooked shank 34 and reservoir 30 withstands higher forces before failure than a straight shank 34. This embodiment is not limited to a specific number of bends in the reservoir 30, or any specific shape of bend (i.e., in some embodiments the bends are at sharp angles, rounded, bent along a 2D plane, or within 3D space such as a helical/spiral bend). FIG. 3 is shown with an enlarged shank 32, but this is not a requirement. The relative sizes of the hollow shank fishing hook 12 and the fishing line 10 will dictate whether it is necessary that the shank be enlarged.

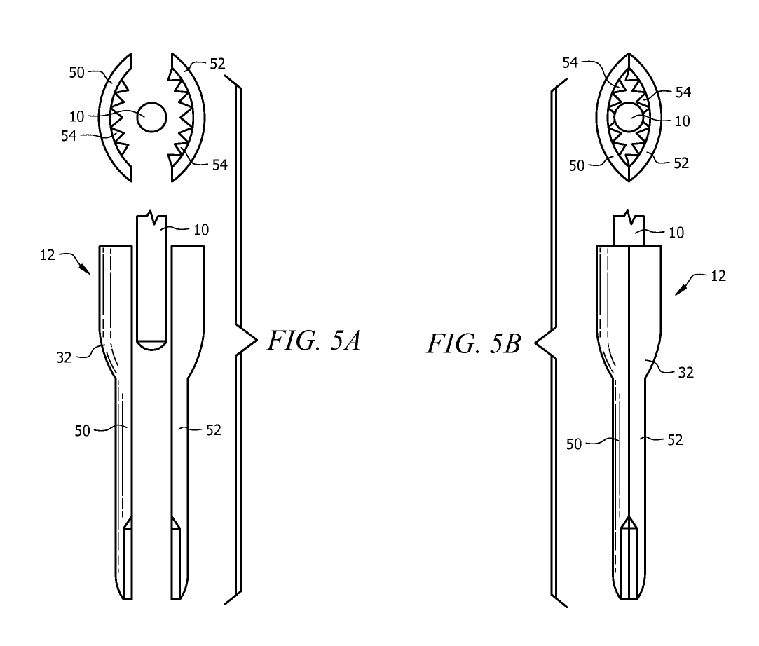

Referring to FIGS. 4A, 4B, 5A and 5B a two part embodiment of the hollow shank fishing hook 12 is discussed. In this embodiment, rather than the fishing line 10 being inserted into the hollow shank of the fishing hook 12, the two sections 50/52 (e.g. halves, but not limited to halves) of the hollow shank fishing hook 12 are joined with the fishing line 10 trapped between the two sections 50/52. In the examples shown, the cross-sectional shape of the hook is generally circular, but any shape is anticipated, including elliptical, square, rectangular, triangular, or any other polygonal shape. This cross sectional shape is elongated to form the length of the shank. The bend generally follows a curved, arcing path, but is not limited to any particular shape. Shapes such as sharp corners, a series of segments, either straight or curved sections, that in the aggregate create a curve, or even a ninety-degree bends that form a hook bottom are some examples. In some embodiments the surface between the two sections 50/52 of the hollow shank fishing hook 12 is flat, but in other embodiments each side is curved, ridged, any other shape that allows the two sections 50/52 to mate. In this embodiment the adhesive 40 is split between the left section 50 of the hook and the right section 52 of the hook, as shown in FIG. 4A. When the two sections 50/52 are joined, as shown in FIG. 4B, the adhesive is activated and forms around the fishing line 10. In some embodiments, the adhesive is separated from the atmosphere by an optional membrane 48, to prevent premature activation. The adhesive cures by any way known in the industry, including, but not limited to, the evaporation of a solvent (e.g., water, alcohol, etc.), a chemical reaction between the adhesive and another chemical (e.g., water vapor, liquid water applied to the fishing line 10 prior to insertion, saliva, oxygen, etc.), or in reaction to an external energy source (e.g., ultraviolet light, heat, etc.). In still other embodiments, the adhesive is a pressure sensitive adhesive. When the two sections 50/52 are combined, as shown in FIG. 4B the adhesive 40 is compressed against the fishing line 10 and forms a bond. In other embodiments, the adhesive is a two or more part adhesive that mixes during the assembly of the two sections 50/52. FIGS. 4A and 4B are shown with an enlarged shank 32, but this is not a requirement. The relative sizes of the fishing hook and the fishing line 10 will dictate whether it is necessary that the shank be enlarged.

It is anticipated that, in some embodiments, additional elements are provided to properly align the two sections 50/52 during assembly, such as a teeth or pegs on one section 50 and associated cavities on the other section 52, ridged surfaces, peaks on one section and valleys on the other, nubs on one section 50 with holes on the other section 52, etc. In some embodiments the reservoir does not exist prior to the joining of the two sections 50/52. In such embodiments, when the two sections 50/52 are combined around the fishing line 10 the reservoir is created within two sections 50/52 to make room for the fishing line 10. Any method as known in the art is anticipated to join the two sections, including adhesives, fusion bonding, hot gas welding, vibration welding, solvent bonding, ultrasonic welding, induction welding, arc welding, gas welding, etc.

FIGS. 5A and 5B show a slightly different embodiment where the adhesive 40 has been replaced by a mechanical means 54, illustrated as teeth. In this embodiment, the fishing line 10 is placed between the fishing hook sections 50/52, the fishing hook sections 50/52 are joined, and the fishing hook two sections 50/52 are bonded together. The fishing line 10 is held in place by teeth, barbs, or pressure from the walls of the fishing hook sections 50/52 that protrude from each section and press against the surface of the fishing line 10. The fishing hook sections 50/52 are compressed against or around the fishing line 10 and bonded together as known in the art, for example by fusion bonding, hot gas welding, vibration welding, solvent bonding, ultrasonic welding, induction welding, arc welding, gas welding. Note that any number of sections 50/52 is anticipated.

In some embodiments, the hollow shank fishing hook 12 is molded around the fishing line 10. In this embodiment, the fishing line 10 is inserted into a mold, and the hollow shank fishing hook 12 is molded around the fishing line 10. In other embodiments, the fishing line 10 is inserted into a still malleable fishing hook 12. In still other embodiments the fishing line 10 ends in a mushroom shape, plug, disc, etc. that locks with indentations in the enlarged shank 32 to prevent the fishing line 10 from being removed after assembly.

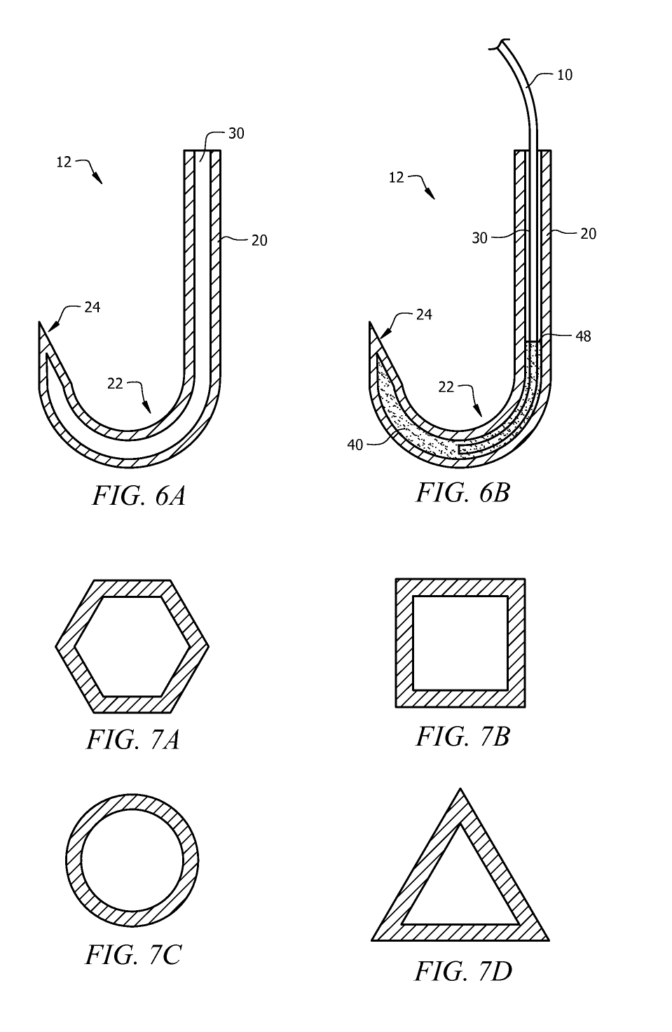

Referring to FIG. 6, a cross-section of another example of the hollow shank fishing hook will be described. In this example, the fishing hook 12 is formed from a shape having a hollow cross-section, one example of such a shape being microtubing. Microtubing is used in the construction of devices used in medicine, aerospace, automotive, and so forth.

The tubing is used to form the reservoir 30, shank 20, and bend 22. The point 24 can be formed in multiple ways, including crimping the end of the tubing, reducing the diameter of the end of the tubing, inserting a plug, welding, and so forth as known in the industry. In Some embodiments, portions of the hollow shank fishing hook 12 are crimped to alter the cross-sectional shape for various purposes. A barb is optionally be formed at the tip 24 using any of the above disclosed methods, or as commonly known in the art.

FIGS. 6A and 6B show the reservoir 30 extending into and through the bend 22. This makes it possible to take advantage of the long reservoir 30, allowing this example of the hollow fishing hook 12 to contain greater adhesive, and resist pure shear force because the fishing line 10 and the walls of the reservoir 30 within the bend 22 are not parallel to the direction of the force. Instead, the load on the adhesive at that point is a mix of shear, tensile, and compressive stresses. Depending on the type of adhesive 40, reservoir 30 material and surface structure, fishing line 10 material and surface structure, the crooked shank 34 and reservoir 30 withstand higher forces before failure than with having adhesive in only the straight portion of the shank 20. This example is not limited to a specific number of bends in the reservoir 30, or any specific shape of bend. The optional membrane 48 is shown, which is needed for certain types of adhesive.

The interior surface of the reservoir 30 can be rough/textured/ribbed/ridged/knobby in some embodiments to increase the strength of the bond between the fishing line 10 and the reservoir 30.

In some embodiments, the microtubing is prefilled with the adhesive 40 prior to the microtubing being formed into the shape of the hollow shank fishing hook 12, where the adhesive 40 is lining on the interior surface of the microtubing.

As discussed above, the cross-sectional shape of the hook in the examples shown is generally circular or elliptical, but any shape is anticipated, including square, rectangular, triangular, or any other regular or irregular polygonal shape. FIGS. 7A-7D shows sample cross sectional shapes, though any shape is anticipated.

Referring to FIGS. 1-7, overall aspects of the hollow shank fishing hook 12 will be discussed. The hollow shank fishing hook 12 is made from any suitable material such as plastic, glass, metal, fiberglass, composite products, carbon fiber, fiber-reinforced polymers, glass-reinforced plastic, carbon-fiber reinforced plastic, etc. The metals used include both ferrous and non-ferrous metals. In one embodiment, the hollow shank fishing hook 12 is made of a material with an index of refraction very close to that of water to minimize visibility to fish.

When combined with the fishing line 10 made of fluorocarbon, only the bait will be visible to the fish, with the fishing line 10 and hollow shank fishing hook 12 being nearly invisible in the water. In other embodiments, the hollow shank fishing hook 12 is colored (e.g., red, green, blue, yellow, and any other color present in the spectrum of light visible to fish), while in other embodiments the hollow shank fishing hook 12 is colorless (i.e., clear). In some embodiments, the adhesive 40/42/44/46 is colored (e.g., red, green, blue, yellow, etc.), while in other embodiments the adhesive 40/42/44/46 is colorless (i.e., clear).

Additionally, in some embodiments the hollow shank fishing hook 12 is of a shape that minimizes drag through the water. This is illustrated in FIGS. 4 and 5, where the hollow shank fishing hook 12 has an elliptical shape that minimizes drag through the water. When combined with the absence of a knot, less turbulence is created as the hook is moved through the water, reducing or eliminating cavitation, and minimizing any noise created by the flow of water around the hook and line. This is yet another means by which the hook minimizes distractions to the fish, allowing the bait to be the main source of attention.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A hollow fishing hook device comprising:
an elongated shank, the shank having a cross-sectional shape with a first end and a second end; and
a reservoir starting in the first end of the elongated shank, the reservoir comprising a hollow portion of the elongated shank; and
the second end of the elongated shank continuing into at least one bent elongated arm, the reservoir continuing through at least a portion of the at least one bent elongated arm, the bent elongated arm ending in a point.

2. The hollow shank fishing hook of claim 1, wherein the reservoir ends at the point.

3. The hollow shank fishing hook of claim 1, wherein the reservoir starts and ends within the bent elongated arm.

4. The hollow shank fishing hook of claim 1 further comprising an adhesive, the adhesive contained within the reservoir.

5. The hollow shank fishing hook of claim 4 wherein the adhesive is a single part adhesive.

6. The hollow shank fishing hook of claim 4 wherein the adhesive is a multiple part adhesive.

7. The hollow shank fishing hook of claim 4 wherein the adhesive is a pressure activated adhesive.

8. The hollow shank fishing hook of claim 4 wherein the adhesive is cured by an energy source.

9. The hollow shank fishing hook of claim 4 wherein the adhesive is separated from the atmosphere by a membrane.

10. The hollow shank fishing hook of claim 1 wherein the hollow shank fishing hook is made of material with an index of refraction nearly identical to water.

11. The hollow shank fishing hook of claim 1 wherein the point is formed by crimping the end of the bent elongated arm.

12. The hollow shank fishing hook of claim 1 wherein the point is formed by machining the end of the bent elongated arm.

13. The hollow shank fishing hook of claim 1 wherein the cross-sectional shape the elongated shank and bent elongated arm is selected from the group of: circular, triangular, square, rectangular, and octoganal.

14. A method of manufacturing a hollow fishing hook device, the steps comprising:
bending a hollow shaft having a hollow cross section to form a hook shape, the hook shape comprising a shank and a bend;
terminating an end of the bend furthest from the shank; and
filling a portion of an interior of the tube with at least one type of adhesive.

15. A method of manufacturing a hollow fishing hook device of claim 13, further comprising the step of inserting a leader line, the leader line contacting the adhesive.

16. A method of manufacturing a hollow fishing hook device of claim 14, further comprising the step of curing the at least one type of adhesive with an energy source.

17. A method of manufacturing a hollow fishing hook device of claim 13, where the end of the bend is terminated by being crimped.

18. A method of manufacturing a hollow fishing hook device of claim 13, where the end of the bend is terminated by being plugged.

19. A hollow fishing hook device comprising:
an elongated hollow shank, the shank having a cross-sectional shape with a first end and a second end; and
a reservoir starting in the first end of the elongated hollow shank, the reservoir comprising at least a portion of the elongated hollow shank;
the second end of the elongated shank continuing into at least one bent elongated hollow arm, the reservoir continuing through at least a portion of the at least one bent elongated hollow arm, the bent elongated hollow arm ending in a point; and
the reservoir at least partially filled with at least one adhesive.
